(19) United States
(12) Patent Application Publication
(10) Pub. No.: US 2024/0308448 A1
(43) Pub. Date: Sep. 19, 2024

(54) VEHICLE SYSTEM ILLUSTRATION GENERATION METHOD AND DISPLAY METHOD, AND METHOD FOR ASSISTING IN FAULT DIAGNOSIS

(71) Applicant: Autel Intelligent Technology Corp., Ltd., Shenzhen (CN)

(72) Inventor: Yiqiang LIU, Shenzhen (CN)

(73) Assignee: Autel Intelligent Technology Corp., Ltd., Shenzhen, GD (CN)

(21) Appl. No.: 18/575,274

(22) PCT Filed: Jul. 1, 2022
(86) PCT No.: PCT/CN2022/103348

§ 371 Date: Dec. 28, 2023

(30) Foreign Application Priority Data
Jul. 8, 2021 (CN) 202110772518.7

(51) Int. Cl. B60R 16/023

(52) U.S. Cl. CPC B60R 16/0234

(57) ABSTRACT

A vehicle system illustration generation method includes: determining, according to vehicle information, function systems included in a vehicle, and parts or modules included in the function systems; acquiring, from a pre-established element database, element information of elements corresponding to the parts or modules included in each function system; and generating, according to the element information of the elements corresponding to the parts or modules included in the function systems, connection relation information corresponding to the parts or modules, and signal flow direction information, system illustrations corresponding to the function systems of the vehicle not only the overall view of the automobile frame can be systematically ascertained as a whole, but also the information flow of the automobile can be clearly and meticulously felt, so that the formation of a diagnosis strategy is assisted to the greatest extent, and the fault point is finally found.

The present application claims priority to Chinese Patent Application No. 202110772518.7, entitled “VEHICLE SYSTEM ILLUSTRATION GENERATION METHOD AND DISPLAY METHOD, AND METHOD FOR ASSISTING IN FAULT DIAGNOSIS”, filed on Jul. 8, 2021 by China Patent Office, which is incorporated herein by reference in its entirety.

### TECHNICAL FIELD

The present application relates to the technical field of vehicle diagnosis, and more particularly to a vehicle system illustration generation method and display method, and method for assisting in fault diagnosis.

### BACKGROUND OF THE INVENTION

In vehicle maintenance, it is necessary to troubleshoot various fault problems, and the premise of troubleshooting is to find where the problems lie in first. With the progress of science and technology, on one hand, it is more frequent to exchange the vehicle data, it is more comprehensive for the use of bus, and the network architecture of vehicles is further complicated; on the other hand, as environmental requirements increase, each automotive control unit requires precise control over more vehicle components, resulting in the need for the automotive control unit to collect and process various signal flows.

When faced with increasingly complex automotive network architectures and more signal flow convergence, there would be high experience requirements for maintenance workers when there are faults in a vehicle. In the prior art, there is a lack of a network architecture diagram capable of systematically exploring the overall appearance of a vehicle frame as a whole and various signal flow direction information when each vehicle control unit works, which makes the fault diagnosis of a vehicle difficult.

### SUMMARY OF THE INVENTION

The embodiments of the present invention aim to provide a vehicle system illustration generation method and display method, and method for assisting in fault diagnosis. Not only the overall view of the vehicle frame can be systematically ascertained as a whole, but also the information flow of the vehicle can be clearly and meticulously felt, so that the formation of a diagnosis strategy is assisted to the greatest extent, and the fault point is finally found.

In order to solve the above technical problem, embodiments of the present invention provide the following technical solutions:

In a first aspect, the present invention provides a vehicle system illustration generation method including:
acquiring vehicle information of a vehicle, the vehicle information including vehicle brand information, vehicle model information, and vehicle configuration information;
determining, according to the vehicle information, parts or modules included in function systems of the vehicle;
acquiring, from a pre-established element database, elements corresponding to the parts or modules included in each function system, wherein the element database includes element information about a plurality of elements, each of the elements corresponds to one part or module, and the element information includes element codes and element pictures;
acquiring connection relation information between the parts or modules included in the function systems and vehicle buses, and signal flow direction information between the parts or modules; and
generating, according to the element information of the elements corresponding to the parts or modules included in the function systems, the connection relation information and the signal flow direction information, system illustrations corresponding to the function systems of the vehicle.

Alternatively, the element database includes a plurality of element groupings, each of the element groupings consists of the elements corresponding to the parts or modules having the same operating principle, and the same element picture in each of the element groupings corresponds to one or more element codes.

Alternatively, the element database further includes a mapping relation between each element and vehicle brand information, and/or vehicle model information, and/or function system identifier, and the acquiring, from a pre-established element database, elements corresponding to the parts or modules included in each function system includes:
acquiring, from a pre-established element database, elements corresponding to the parts or modules included in each function system of the vehicle according to the vehicle information and each of the function system identifiers.

Alternatively, the generating, according to the element information of the elements corresponding to the parts or modules included in the function systems, the connection relation information and the signal flow direction information, system illustrations corresponding to the function systems of the vehicle includes:
generating, according to the element information of the elements corresponding to the parts or modules included in the function systems and the connection relation information, network architectures corresponding to the function systems of the vehicle, and
generating, according to the element information of the elements corresponding to the parts or modules included in the function systems and the signal flow direction information, signal architectures corresponding to the function systems of the vehicle.

Alternatively, the parts or modules in the network architectures are identified using corresponding element codes, and connection lines between the parts or modules and different vehicle buses are identified using different colors; the parts or modules in the signal flow architectures are identified using corresponding element codes plus element pictures, and each of the signal flow directions between the parts or modules is identified using an arrow and a signal flow sequence number.

In a second aspect, the present invention provides a display method for a vehicle system illustration, the method including:
acquiring a function system identifier of one of the function systems of the vehicle;
acquiring, according to the function system identifier, the system illustrations corresponding to the function systems, wherein the system illustrations are generated using the method for generating the system illustrations described in any one of the above;
acquiring a system illustration file corresponding to the function system according to the function system identifier; and
associating the system illustration with the system illustration file for display.

Alternatively, the method further includes:
arranging, according to the function systems included in the vehicle, and parts or modules included in the function systems, corresponding system illustration files for the function systems of the vehicle, wherein the system illustration files include at least one of a functional illustration file, a part illustration file, a signal flow illustration file, and a case illustration file.

In a third aspect, the present invention provides a method for assisting in fault diagnosis, the method including:
acquiring fault codes of the vehicle;
determining, according to the failure codes, parts or modules that are likely to fail;
acquiring, according to each part or module that is likely to fail, a function system identifier of a function system to which the part or module belongs;
acquiring, according to the function system identifier, the system illustrations corresponding to the function systems, wherein the system illustrations are generated using the method for generating the system illustrations described in any one of the above;
acquiring a system illustration file corresponding to the function system according to the function system identifier; and
associating the system illustration with the system illustration file for display.

In a fourth aspect, the present invention provides an electronic device including a processor and a memory having stored thereon a computer program which, when executed by the processor, causes the processor to perform the method for any of the above.

In a fifth aspect, the present invention provides a readable storage medium storing a computer program which, when executed by a processor, performs the method for any of the above.

Advantageous effects of embodiments of the present invention are: unlike the prior art, in an embodiment of the present invention, first function systems included in a vehicle, and parts or modules included in the function systems are determined according to vehicle information; second, element information of the elements corresponding to the parts or modules included in the function systems are acquired from a pre-established element database; third, connection relation information corresponding to the parts or modules, and signal flow direction information, system illustrations corresponding to the function systems of the vehicle are generated according to the element information of the elements corresponding to the parts or modules included in the function systems. Not only the overall view of the vehicle frame can be systematically ascertained as a whole, but also the information flow of the vehicle can be clearly and meticulously felt, so that the formation of a diagnosis strategy is assisted to the greatest extent, and the fault point is finally found.

### BRIEF DESCRIPTION OF DRAWINGS

One or more embodiments are illustrated by way of example and not by way of limitation in the figures of the accompanying drawings, in which elements having the same reference numeral designations represent similar elements, and in which the figures are not to scale unless otherwise specified.

FIG. 1 is a flowchart illustrating a vehicle system illustration generation method according to an embodiment of the present invention;

FIG. 2a is a schematic diagram of a vehicle instrument panel according to an embodiment of the present invention;

FIG. 2b is a schematic diagram of an element picture generated from a dashboard of the vehicle of FIG. 2a;

FIG. 3 is a schematic diagram after importing some elements in an element database into an excel table according to an embodiment of the present invention;

FIG. 4 is a schematic diagram of a network architecture diagram according to an embodiment of the present invention:

FIG. 5 is a schematic diagram of a signal flow diagram according to an embodiment of the present invention;

FIG. 6 is a schematic diagram illustrating a wireless transmission function according to an embodiment of the present invention;

FIG. 7 is a flowchart showing a method for a vehicle system illustration according to an embodiment of the present invention,

FIG. 8 is a flowchart of a method for assisting in fault diagnosis according to an embodiment of the present invention:

FIG. 9 is a block diagram of an alternative electronic device according to an embodiment of the present invention.

### DETAILED DESCRIPTION OF THE INVENTION

In order that the objects, aspects and advantages of the embodiments of the present invention will become more apparent, a more complete description of the embodiments of the present invention will be rendered by reference to the appended drawings, which are provided to illustrate, by way of example, some, but not all embodiments of the present invention. Based on the embodiments of the present invention, all other embodiments obtained by a person of ordinary skill in the art without inventive effort fall within the scope of the present invention.

Furthermore, the technical features involved in the various embodiments of the present invention described below can be combined with each other as long as they do not conflict with each other.

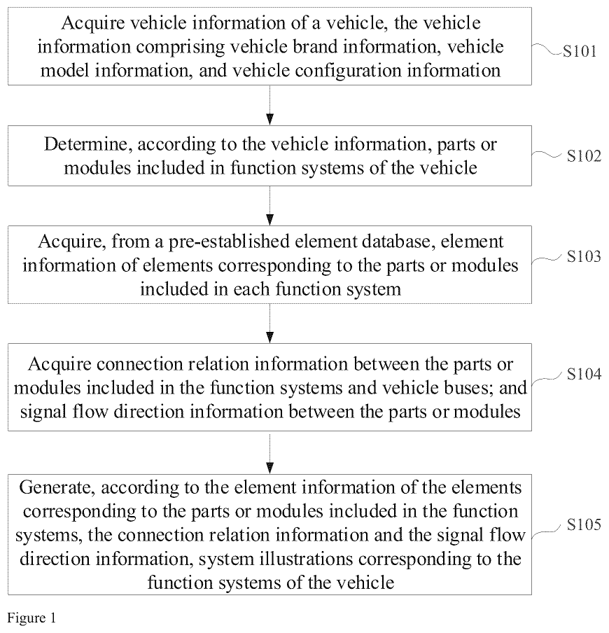

Referring to FIG. 1, FIG. 1 is a flowchart illustrating a vehicle system illustration generation method applicable to a vehicle system itself or a vehicle maintenance system or a vehicle production system according to an embodiment of the present invention, the method including:

step S101: acquire vehicle information of a vehicle, the vehicle information including vehicle brand information, vehicle model information, and vehicle configuration information.

Specifically, the vehicle brand information, the vehicle model information and the vehicle configuration information of the vehicle can be searched from a vehicle central gateway database which is a pre-set database in which the vehicle configuration information of various brands and vehicle models is stored.

Step S102: Determine, according to the vehicle information, parts or modules included in function systems of the vehicle.

In general, a vehicle includes four parts of an engine, a chassis, a vehicle body, and electrical equipment. The engine includes a fuel supply system, a lubrication system, a cooling system, an ignition system, and a starting system; the chassis includes a transmission system, a driving system, a steering system, and a braking system; the electrical equipment includes various auxiliary systems such as vehicle lights, instruments, and radar. In general, each of the function systems consists of a control unit component for governing operation of the other the parts or modules in the function system and a plurality of other the parts or modules. The function systems of different vehicle types also include different the parts or modules.

Step S103: Acquire, from a pre-established element database, elements corresponding to the parts or modules included in each function system.

The element database includes element information about a plurality of elements, each of the elements corresponds to one part or module, and the element information includes element codes and element pictures. The element code may be consistent with the codes for the parts or modules for the vehicle brands. Different the parts or modules are coded differently for the same brand. The element database may be created by individual vehicle brand service providers or by professional vehicle repair companies.

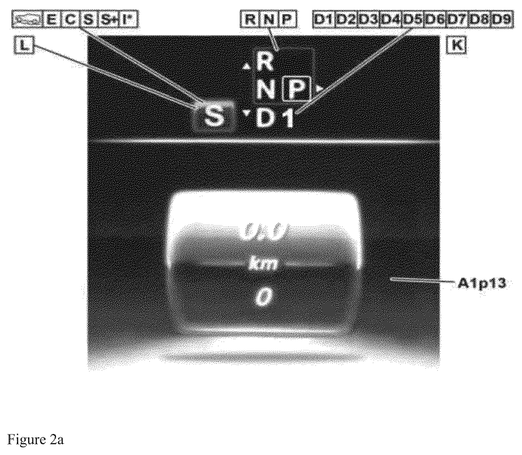

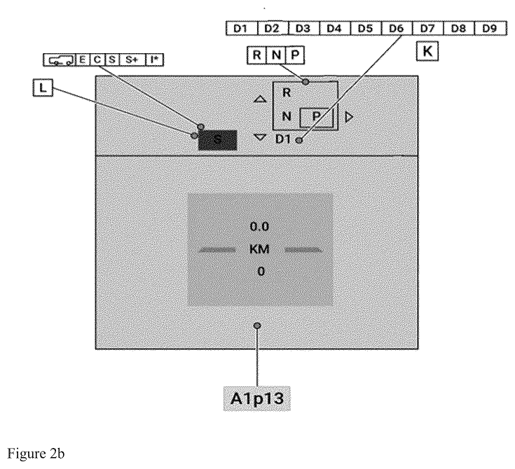

In some embodiments, the element database stores various vehicle brands, element information for the parts or modules included in various vehicle models. When establishing this element database, firstly the information of maintenance data, training data and electrical function diagram of various vehicle brands and various vehicle types is collected, and the collected information is classified based on the modules or components of the same working principle for modeling. For example, pressure sensors in different systems of various vehicle models of brands may be grouped into one category, which may occur in front of the valve or behind the valve of an intake line in an engine system; it may also be present in air spring, variable body suspension (shock absorption) systems. For a well-classified module or component, a model is made according to its appearance structure to form a uniform pattern, and the pictures of the parts or modules after the re-modeling are stored into an element database in groups. Reference is now made to FIGS. 2a and 2b, wherein FIG. 2a is a schematic illustration of a vehicle dashboard according to an embodiment of the present invention, and FIG. 2b is a schematic illustration of an element picture generated from the vehicle dashboard of FIG. 2a.

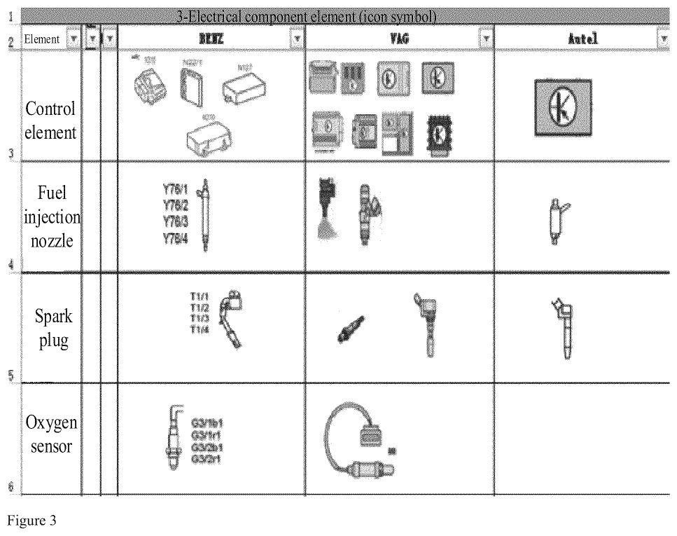

The element database constructed in the above-mentioned manner includes a plurality of element groupings, wherein each of the element groupings is composed of corresponding elements of the parts or modules having the same operating principle, and the same element picture in each of the element groupings corresponds to one or more element codes. As shown in FIG. 3, a schematic diagram after importing a part of elements in an element database into an excel table is provided for an embodiment of the present invention, wherein the left column is an element grouping name, and under each of the element groupings, the elements are divided by the vehicle brand. For example, under the element grouping of “fuel nozzle”, there are four element codes under the brand of BENZ vehicle, which all correspond to the same picture of “fuel nozzle”, namely Y76/1, Y76/2, Y76/3 and Y76/4.

In some embodiments, in order to improve data query efficiency and storage efficiency, when establishing an element database including various brands, the parts or modules of various vehicle models, mapping relations among the elements and vehicle brand information, and/or vehicle model information, and/or function system identifier are also established, wherein the acquiring element information about the elements corresponding to the parts or modules included in the function systems from a pre-established element database includes: acquiring, from a pre-established element database, elements corresponding to the parts or modules included in each function system of the vehicle according to the vehicle information and each of the function system identifiers. Specifically, a corresponding element grouping can be found first according to a part or module name, and further a corresponding element can be found under the element grouping according to the vehicle information and function system identifier. It will be appreciated that due to the large number and types of the parts or modules included in a vehicle, some the parts or modules may be shared among different models and different function systems of the same brand, some the parts or modules may be shared among the same models of the same brand, and some the parts or modules may be shared among the same function systems of the same brand. Therefore, there is a mapping relation between the elements in some element groupings and only the vehicle brand, there is a mapping relation between the elements in some element groupings and the vehicle brands plus the vehicle models, and there is a mapping relation between the elements in some element groupings and the vehicle brands plus the function systems, and when the mapping relation between each element and the vehicle brand information, and/or the vehicle model information, and/or the function system identifier is established, it is sufficient to establish the mapping relation between each element and the vehicle brand information, and/or the vehicle model information, and/or the function system identifier according to actual needs.

S104 Acquire connection relation information between the parts or modules included in the function systems and vehicle buses, and signal flow direction information between the parts or modules.

Specifically, a connection relation information between the part or module included in each of the function systems and each vehicle bus, and the signal flow direction information between the parts or modules are counted in advance, and stored according to preset rules. For example, (A, set Line) can be used to identify the connection relation information of one part or module with each vehicle bus, wherein A represents the part or module, and all buses to which the part or module is connected are represented in the set Line. A piece of signal flow information is identified by using (a signal flow sequence number, a set B, a set C, and a Line), wherein the set B represents a set composed of outgoing the parts or modules corresponding to the signal flow, the set C represents a set composed of incoming the parts or modules corresponding to the signal flow, and the Line represents a bus through which the signal flow flows.

S105 Generate, according to the element information of the elements corresponding to the parts or modules included in the function systems, the connection relation information and the signal flow direction information, system illustrations corresponding to the function systems of the vehicle.

Specifically, according to the element information of the elements corresponding to the parts or modules included in the function systems and the connection relation information, network architectures corresponding to the function systems of the vehicle is generated, and

according to the element information of the elements corresponding to the parts or modules included in the function systems and the signal flow direction information, signal architectures corresponding to the function systems of the vehicle are generated.

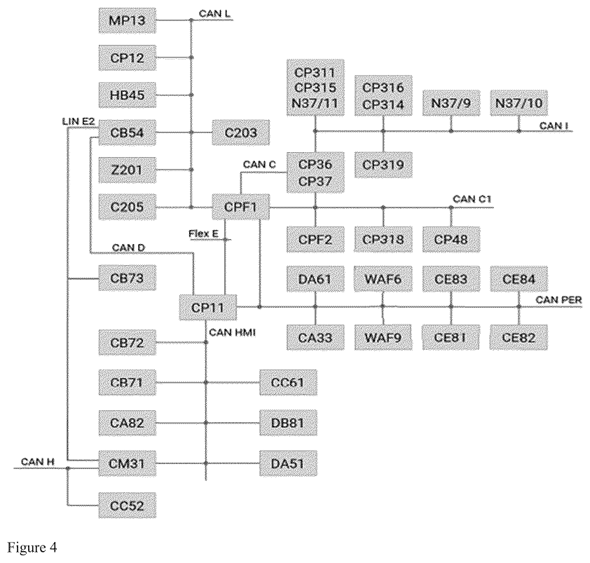

The network relation in a vehicle is complicated, and in the prior art, the interconnection of the parts or modules are mostly expressed through a circuit diagram, and when there are too many components in the circuit diagram, there is too much information to be consulted, and when there are too few components in the circuit diagram, the whole relation of interconnection cannot be completely expressed. To solve this problem, embodiments of the present invention provide a method for generating a network architecture diagram. FIG. 4 is a schematic diagram of a network architecture diagram provided for an embodiment of the present invention. The network architecture is drawn and generated according to a connection relation between the parts or modules and each vehicle bus in a function system, wherein the parts or modules are identified using an element code corresponding to the parts or modules, and the connection lines between the parts or modules and different vehicle buses identify different buses using different colors. Through the network architecture, an overall perspective of the function system can be systematically explored.

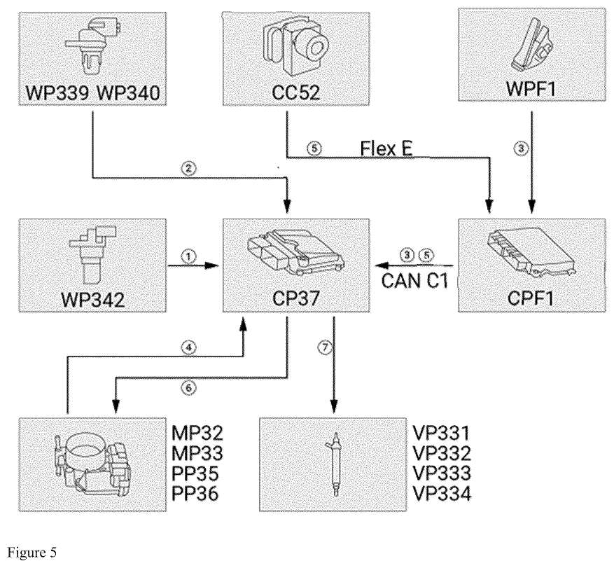

In order to help the user to understand the working principle of each of the function systems, the working schematic diagram of each function system is mostly provided, but the working schematic diagram cannot express the working logic of the control unit, so that the user cannot fully understand the working principle of each function system. To better express the operation logic of the control unit in each function system, embodiments of the present invention provide a method for generating a signal flow graph. FIG. 5 is a schematic diagram of a signal flow diagram provided for an embodiment of the present invention. The parts or modules in the signal flow architectures are identified using corresponding element codes plus element pictures, and each of the signal flow directions between the parts or modules is identified using an arrow and a signal flow sequence number. Specifically, numbers are circled in the figure, and the size of the numbers indicates the precedence of signal transmission.

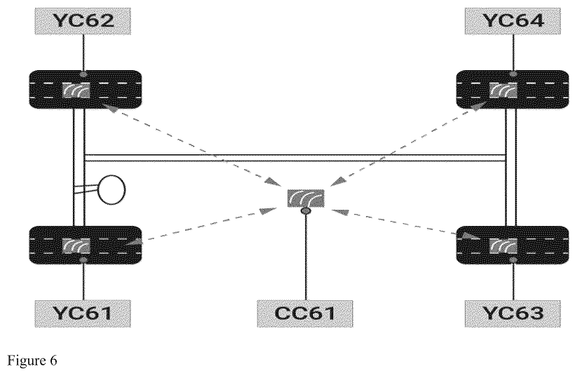

In vehicle systems, some function systems operate through wireless technology communication, and embodiments of the present invention are also used to generate wireless transmission functional diagrams according to the wireless connection between the parts or modules. FIG. 6 is a schematic diagram illustrating a wireless transmission function according to an embodiment of the present invention.

In an embodiment of the present invention, first function systems included in a vehicle, and parts or modules included in the function systems are determined according to vehicle information; second, element information of the elements corresponding to the parts or modules included in the function systems are acquired from a pre-established element database; third, connection relation information corresponding to the parts or modules, and signal flow direction information, system illustrations corresponding to the function systems of the vehicle are generated according to the element information of the elements corresponding to the parts or modules included in the function systems; wherein the network architecture in the system illustration supports various complex bus network architecture relations, and the overall appearance of the vehicle frame can be systematically explored as a whole; through the signal flow architecture in the system illustration, the information flow of a vehicle can be clearly and meticulously sensed.

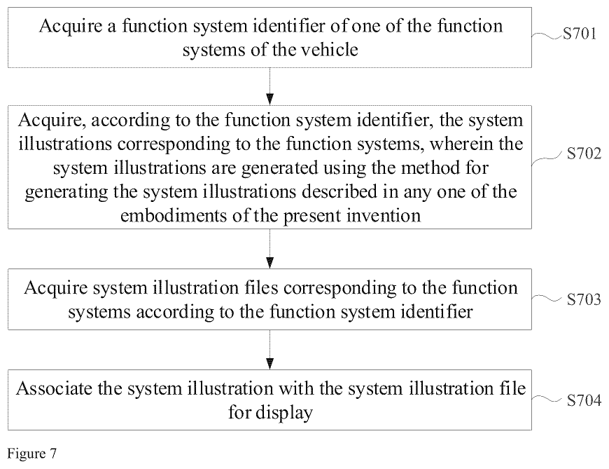

Referring to FIG. 7, FIG. 7 is a flowchart showing a method for illustrating a vehicle system illustration in an embodiment of the present invention, the method is applicable to a vehicle own system or a vehicle maintenance system, and the method includes:

S701 Acquire a function system identifier of one of the function systems of the vehicle.

In some embodiments, a system illustration corresponding to each function system of the vehicle is stored in advance on the vehicle.

In some embodiments, a system illustration corresponding to each function system of each vehicle is stored in advance in a server of the vehicle maintenance system. The step S701 also serves to acquire vehicle information such as vehicle brand information, vehicle model information, and vehicle configuration information. A system illustration corresponding to each function system of the vehicle is selected based on the vehicle information.

Step S702 Acquire, according to the function system identifier, the system illustrations corresponding to the function systems, wherein the system illustrations are generated using the method for generating the system illustrations described in any one of the embodiments of the present invention.

The system illustration includes a network architecture diagram and a signal flow architecture diagram.

Step S703 Acquire system illustration files corresponding to the function systems according to the function system identifier.

Specifically, the method includes arranging, according to the function systems included in the vehicle, and parts or modules included in the function systems, corresponding system illustration files for the function systems of the vehicle, wherein the system illustration files include at least one of a functional illustration file, a part illustration file, a signal flow illustration file, and a case illustration file. The functional illustration file is used to introduce the normal working principle and situation of current function system in various situations; the part illustration file is used to describe the parts or modules included in the current function system; the signal flow illustration file is used for describing each signal flow in the signal flow architecture, and the case illustration file is used for describing the maintenance case of relevant failure of the current function system as well as the safety matters needing attention in the maintenance.

Step S704 Associate the system illustration with the system illustration file for display.

Since there may be a plurality of system illustration files corresponding to the system illustrations of the function systems, in some embodiments, for the convenience of presentation, illustration files corresponding to the system illustration file types are acquired according to the system illustration file types input by a user; the illustration files are shown in association with the system illustration files. Specifically, a system illustration file switching button can be set on a system illustration display page, and corresponding system illustration files are displayed according to a user selection. For example, when the currently displayed system illustrations are signal flow architectures, when the user selects “viewing a part illustration file”, the signal flow architectures are displayed in association with the part illustration files corresponding to the signal flow architectures, for example, the signal flow architectures are displayed at an upper part of the interface, and the part illustration files corresponding to the parts included in the signal flow architectures are displayed at a lower part of the interface. Similarly, when the user selects other illustration files, the signal flow architectures are displayed in the same or similar association with other illustration files corresponding to the signal flow architectures. It can be appreciated that when a user views a network architecture of the function system, an association view can be performed among three files, i.e., a functional illustration file, a part illustration file and a case illustration file, corresponding to the function system.

In an embodiment of the present invention, by means of associating and displaying a system illustration figure with a corresponding system illustration file, a graphic and text display mode is provided to help a user to understand the network architectures and signal flows of the function systems.

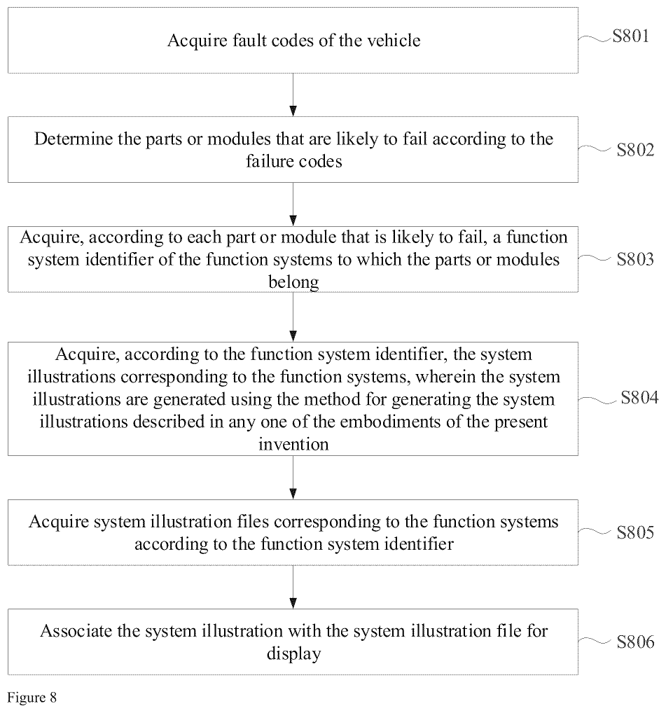

Referring to FIG. 8, FIG. 8 is a flowchart of a method for assisting in fault diagnosis, which is applicable to a vehicle-own system or a vehicle service system, according to an embodiment of the present invention, and the method includes:

Step S801 Acquire fault codes of the vehicle.

In some embodiments, the fault codes of the vehicle are acquired by a vehicle diagnostic measurement device in communication with the vehicle.

In some embodiments, the vehicle fault codes input by a user are acquired.

Step S802 Determine the parts or modules that are likely to fail according to the failure codes.

A mapping relation between the fault codes and the parts or modules of the vehicle is established in advance. The parts or modules that are likely to fail can be located by failure codes.

Step S803 Acquire, according to each part or module that is likely to fail, a function system identifier of the function systems to which the parts or modules belong.

Step S804 Acquire, according to the function system identifier, the system illustrations corresponding to the function systems, wherein the system illustrations are generated using the method for generating the system illustrations described in any one of the embodiments of the present invention.

Step S703 Acquire system illustration files corresponding to the function systems according to the function system identifier.

Step S806 Associate the system illustration with the system illustration file for display.

Steps S804 to S806 are implemented in the same manner as steps S702 to S704 in FIG. 7, and reference can be made to the above description for details, which will not be repeated here.

In an embodiment of the present invention, by establishing an association relation between a fault code and a part or module, a system illustration and a system illustration file corresponding to a function system to which the parts or modules belong can be acquired via the fault code to display when a vehicle has a fault to assist a user in diagnosing the fault.

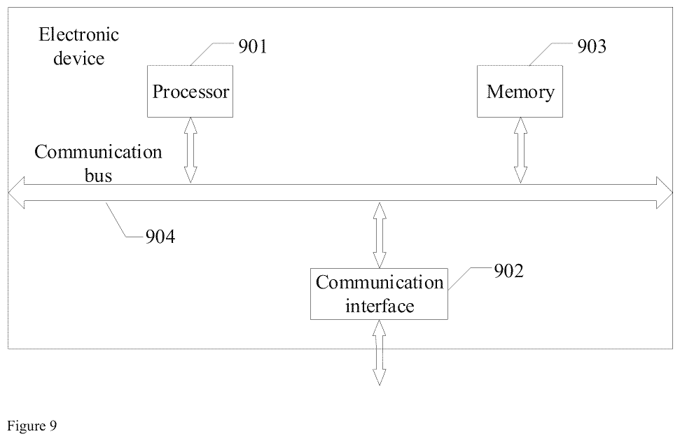

According to an embodiment of the present invention, an electronic device is provided, as shown in FIG. 9, which is an optional electronic device provided for an embodiment of the present invention, and the electronic device may include a processor 901, a communication interface 902, a memory 903 and a communication bus 904, wherein the processor 901, the communication interface 902 and the memory 903 communicate with each other via the communication bus 904. The processor 901 may call the logic instructions in the memory 903 to perform any one of the vehicle system illustration graph generation method, the presentation method, and the auxiliary fault diagnosis method according to an embodiment of the present invention, for example, the method including: acquiring vehicle information about a vehicle, wherein the vehicle information includes vehicle brand information, vehicle model information and vehicle configuration information; determining the parts or modules included in the function systems of the vehicle from the vehicle information; acquiring element information about the elements corresponding to the parts or modules included in the function systems from a pre-established element database, wherein the element database includes element information about a plurality of elements, each of the elements corresponding to a part or module, and the element information including an element code and an element picture; acquiring connection relation information between the parts or modules included in the function systems and each vehicle bus, and signal flow direction information between the parts or modules; generating, according to the element information of the elements corresponding to the parts or modules included in the function systems, the connection relation information and the signal flow direction information, system illustrations corresponding to the function systems of the vehicle.

Furthermore, the logic instructions in the memory 903 described above may be implemented in the form of software functional units and may be stored in a plurality of computer-readable storage media when sold or used as a stand-alone product. Based on such an understanding, the technical solution of the present invention, in essence or in a contribution to the prior art, or a part of the technical solution, can be embodied in the form of a software product, wherein a computer software product is stored in a storage medium, and includes a plurality of instructions for causing a computer device (which may be a personal computer, a server or a network device, etc.) to execute all or part of the steps of the method for generating a digital textile print file or the method for digital textile printing in an embodiment of the present invention. The storage medium includes: various media that can store the program code, such as a U-disk, a removable hard disk, a Read-Only Memory (ROM), a Random Access Memory (RAM), a magnetic or optical disk.

According to an embodiment of the present invention, a readable storage medium storing a computer program is provided, which when executed by a processor, causes the processor to execute the steps of any one of a vehicle system illustration generation method, an exhibition method, and an auxiliary fault diagnosis method in an embodiment of the present invention.

From the above description of the embodiments, it will be clear to a person skilled in the art that the embodiments can be implemented by means of software plus a general-purpose hardware platform, but also by means of hardware. With this in mind, some of the above-described aspects in essence or in a contribution to the art may be embodied in the form of a software product, which may be stored on a readable storage medium, such as an ROM/RAM, magnetic diskette, optical disk, etc. containing instructions for causing a computer device, which may be a personal computer, a server, or a network appliance, etc. to perform the methods of the various embodiments or portions of the embodiments.

Finally, it should be noted that: the above-mentioned embodiments are merely illustrative of the technical solution of the present invention, and do not limit same; under the idea of the present invention, the technical features in the above embodiments or in different embodiments may also be combined, the steps may be implemented in any order, and there are many other variations of the different aspects of the present invention as described above, which are not provided in detail for the sake of brevity; although the present invention has been described in detail with reference to the foregoing embodiments, those skilled in the art will appreciate that: the technical solutions disclosed in the above-mentioned embodiments can still be amended, or some of the technical features thereof can be replaced by equivalents; however, these modifications or substitutions do not bring the essence of the corresponding technical solutions out of the scope of the technical solutions of the various embodiments of the present invention.

1. A vehicle system illustration generation method, comprising:
acquiring vehicle information of a vehicle, the vehicle information comprising vehicle brand information, vehicle model information, and vehicle configuration information;
determining, according to the vehicle information, parts or modules included in function systems of the vehicle;
acquiring, from a pre-established element database, elements corresponding to the parts or modules included in each function system, wherein the element database includes element information about a plurality of elements, each of the elements corresponds to one part or module, and the element information includes element codes and element pictures;
acquiring connection relation information between the parts or modules included in the function systems and vehicle buses, and signal flow direction information between the parts or modules; and
generating, according to the element information of the elements corresponding to the parts or modules included in the function systems, the connection relation information and the signal flow direction information, system illustrations corresponding to the function systems of the vehicle.

2. The method according to claim 1, wherein the element database comprises a plurality of element groupings, each of the element groupings consists of the elements corresponding to the parts or modules having the same operating principle, and the same element picture in each of the element groupings corresponds to one or more element codes.

3. The method according to claim 2, wherein the element database further comprises a mapping relation between each element and vehicle brand information, and/or vehicle model information, and/or function system identifier, and the acquiring, from a pre-established element database, elements corresponding to the parts or modules included in each function system comprises:
acquiring, from a pre-established element database, elements corresponding to the parts or modules included in each function system of the vehicle according to the vehicle information and each of the function system identifiers.

4. The method according to claim 1, wherein the generating, according to the element information of the elements corresponding to the parts or modules included in the function systems, the connection relation information and the signal flow direction information, system illustrations corresponding to the function systems of the vehicle comprises:
generating, according to the element information of the elements corresponding to the parts or modules included in the function systems and the connection relation information, network architectures corresponding to the function systems of the vehicle, and
generating, according to the element information of the elements corresponding to the parts or modules included in the function systems and the signal flow direction information, signal architectures corresponding to the function systems of the vehicle.

5. The method according to claim 4, wherein the parts or modules in the network architectures are identified using corresponding element codes, and connection lines between the parts or modules and different vehicle buses are identified using different colors; the parts or modules in the signal flow architectures are identified using corresponding element codes plus element pictures, and each of the signal flow directions between the parts or modules is identified using an arrow and a signal flow sequence number.

6. A method for displaying vehicle system illustrations, wherein the method comprises:
acquiring a function system identifier of one of the function systems of the vehicle;
acquiring, according to the function system identifier, a system illustration corresponding to the function system, wherein the system illustration is generated using the method comprising steps of: acquiring vehicle information of a vehicle, the vehicle information comprising vehicle brand information, vehicle model information, and vehicle configuration information;
determining, according to the vehicle information, parts or modules included in function systems of the vehicle;
acquiring, from a pre-established element database, elements corresponding to the parts or modules included in each function system, wherein the element database includes element information about a plurality of elements, each of the elements corresponds to one part or module, and the element information includes element codes and element pictures;
acquiring connection relation information between the parts or modules included in the function systems and vehicle buses, and signal flow direction information between the parts or modules; and
generating, according to the element information of the elements corresponding to the parts or modules included in the function systems, the connection relation information and the signal flow direction information, system illustrations corresponding to the function systems of the vehicle;
acquiring a system illustration file corresponding to the function system according to the function system identifier; and
associating the system illustration with the system illustration file for display.

7. The method according to claim 6, further comprising:
arranging, according to the function systems included in the vehicle, and parts or modules included in the function systems, corresponding system illustration files for the function systems of the vehicle, wherein the system illustration files include at least one of a functional illustration file, a part illustration file, a signal flow illustration file, and a case illustration file.

8. (canceled)

9. An electronic device, comprising a processor and a memory having stored thereon a computer program which, when executed by the processor, causes the processor to carry out the method comprising steps of:
acquiring vehicle information of a vehicle, the vehicle information comprising vehicle brand information, vehicle model information, and vehicle configuration information;
determining, according to the vehicle information, parts or modules included in function systems of the vehicle;
acquiring, from a pre-established element database, elements corresponding to the parts or modules included in each function system, wherein the element database includes element information about a plurality of elements, each of the elements corresponds to one part or module, and the element information includes element codes and element pictures;
acquiring connection relation information between the parts or modules included in the function systems and vehicle buses, and signal flow direction information between the parts or modules; and
generating, according to the element information of the elements corresponding to the parts or modules included in the function systems, the connection relation information and the signal flow direction information, system illustrations corresponding to the function systems of the vehicle.

10. (canceled)

11. The device according to claim 9, wherein the element database comprises a plurality of element groupings, each of the element groupings consists of the elements corresponding to the parts or modules having the same operating principle, and the same element picture in each of the element groupings corresponds to one or more element codes.

12. The device according to claim 11, wherein the element database further comprises a mapping relation between each element and vehicle brand information, and/or vehicle model information, and/or function system identifier, and wherein the processor executes the step of acquiring, from a pre-established element database, elements corresponding to the parts or modules included in each function system, the processor further executes a step of:
acquiring, from a pre-established element database, elements corresponding to the parts or modules included in each function system of the vehicle according to the vehicle information and each of the function system identifiers.

13. The device according to claim 9, wherein the processor executes the step of generating, according to the element information of the elements corresponding to the parts or modules included in the function systems, the connection relation information and the signal flow direction information, system illustrations corresponding to the function systems of the vehicle, the processor further executes a step of:
generating, according to the element information of the elements corresponding to the parts or modules included in the function systems and the connection relation information, network architectures corresponding to the function systems of the vehicle, and
generating, according to the element information of the elements corresponding to the parts or modules included in the function systems and the signal flow direction information, signal architectures corresponding to the function systems of the vehicle.

14. The device according to claim 13, wherein the parts or modules in the network architectures are identified using corresponding element codes, and connection lines between the parts or modules and different vehicle buses are identified using different colors; the parts or modules in the signal flow architectures are identified using corresponding element codes plus element pictures, and each of the signal flow directions between the parts or modules is identified using an arrow and a signal flow sequence number.
